(19) United States
(12) Patent Application Publication
(10) Pub. No.: US 2017/0326493 A1
(43) Pub. Date: Nov. 16, 2017

(54) PLEATED FILTER STRUCTURE FOR AIR CLEANING AND AIR FILTERING METHOD

(71) Applicant: KONINKLIJKE PHILIPS N.V., EINDHOVEN (NL)

(72) Inventors: JOHAN MARRA, EINDHOVEN (NL); JING SU, EINDHOVEN (NL)

(21) Appl. No.: 15/520,669

(22) PCT Filed: Oct. 15, 2015
(86) PCT No.: PCT/EP2015/073826

§ 371 Date: Apr. 20, 2017

(30) Foreign Application Priority Data
Oct. 28, 2014 (CN) PCT/CN2014/089657
Feb. 3, 2015 (EP) 15153659.6

(51) Int. Cl. B01D 53/04; F24F 3/16; B01D 53/86

(52) U.S. Cl. CPC B01D 53/0407; B01D 53/8653; F24F 3/1603; B01D 2253/102; B01D 2255/9155; F24F 2003/1628; B01D 2257/708

(57) ABSTRACT

A pleated filter structure is provided for the removal of gaseous pollutants from a gas mixture to be filtered. The structure comprises an ideally air impervious filter sheet, being pleated so as to form an adjacent series of slit shaped conduits for the passage of air through the structure, each bounded on either side by the folded sections of the filter sheet, these being joined by a series of top creases and bottom creases. The top and/or bottom creases incorporate slit-shaped openings allowing passage of a gas mixture into and/or out of the structure. Gas to be filtered enters through one side of the structure, passes laterally across the filter sheet section surfaces and exits through the other side. Also provided are methods for the manufacture of a pleated filter structure, comprising forming rows of slit-shaped openings in a filter sheet and providing folds, in alternating directions, along the lengthwise extensions of adjacent rows of openings. Methods for filtering a gas are also provided.

### FIELD OF THE INVENTION

The invention relates to methods and apparatus for filtering gaseous pollutants from a gas to be filtered, and methods of production of said apparatus.

### BACKGROUND OF THE INVENTION

Indoor air pollution presents a significant health hazard in many urbanized areas across the world. Air pollution sources are encountered both outdoors (e.g. from motor vehicles and industry) and indoors (from cooking, smoking, candle burning, incense burning, outgassing building/decoration materials, use of outgassing waxes, paints, polishes etc.). The pollution level indoors is often higher than outdoors. At the same time, many people reside most of their time indoors and may thus be almost continuously exposed to unhealthy levels of air pollution.

One method to improve the indoor air cleanliness is by installing an air cleaner indoors which is capable of continuously recirculating the indoor air through a cleaning unit comprising one or more air filters. Another method to improve the indoor air cleanliness is by applying continuous ventilation with filtered outdoor air. In the latter case, the air filter(s) are usually comprised in a heating, ventilation and air conditioning (HVAC) system capable of temperature adjustment, ventilation, and of cleaning the ventilation air drawn from outdoors by passing it first through one or more air filters before releasing it indoors. Ventilation with cleaned outdoor air displaces polluted indoor air and dilutes the pollution level therein.

For removing airborne particles from air, a wide choice of mechanical dust filters is available on the market. A mechanical dust filter comprises a dense fibrous sheet/cloth material capable of trapping airborne particles when polluted air is passed through the filter. To increase the surface area of the filter, it is common practice to pleat the fibrous cloth. Filter pleating is a well-established industrial process.

FIGS. 1a-c depict a simple example of a pleated mechanical dust filter well known from the prior art. A single sheet of fibrous cloth material 10 is folded to form the pleated filter structure 12. Air to be filtered 14 is passed through the surface of the cloth, trapping pollutant particles in the material as it does so.

For removing polluting gases from air, use of often made of activated carbon filters which are capable of adsorbing/removing many volatile organic hydrocarbon gases (VOCs) and several inorganic gases (NO2, O3, radon) from air. The activated carbon material is usually present as granules that are contained in an air-permeable filter frame structure. Here, frame pleating is also used. However, pleating also increases the filter volume and the filter frame is typically more costly than the carbon contained therein.

For removing formaldehyde and/or small acidic gases (SO2, acetic acid, formic acid, HNOx) from air, activated carbon as such is not very effective. Instead, use can be made of impregnated filter materials capable of chemically absorbing these gases from air. Absorption can occur via acid-base interactions or through a chemical condensation reaction. Activated carbon granules can be used as the impregnation carrier, but also hydrophilic fibrous cellulose paper or glass-fibre sheet material is suitable for this purpose.

U.S. Pat. No. 6,071,479 discloses the use of corrugated and parallel-plate gas filter structures comprising chemically-impregnated paper or glass-fibre material.

In FIG. 2 is shown an example 20 of such known corrugated filter structure, and in FIG. 3 is similarly shown an example of a parallel plate filter structure 28. The benefit of these filter structures is associated with their comparatively much lower incurred air pressure drop and much smaller filter volume when compared with a (pleated) granular filter structure of the same filter lifetime and filter functionality. Lower air pressure drop across the filter follows from the fact that air flow 22 is parallel to active filtering surfaces 24, 30, passing laterally over filter surfaces as opposed to perpendicularly across or through surfaces, as for example is the case for pleated particular filters, such as the example of FIGS. 1a-c. Reduced air pressure drop means that air may be passed through the filter structure with less effort, mitigating energy costs where the filter is for example fan or vacuum-assisted, or allowing for a faster flow rate of air across the device. Hence, the use of a corrugated or parallel-plate filter structure is generally preferred above the use of a granular filter structure.

An important disadvantage of the corrugated filter structure and parallel-plate filter structure for air cleaning proposed in U.S. Pat. No. 6,071,479 is that their industrial manufacture is troublesome. As yet, no industrial process exists that is suitable for the mass-manufacture of these filter structures at low cost. At the same time, the pleating of dust filter sheets composed of fibrous material is an industrially mature process (see FIG. 1a). Sheet pleating extends the available filter surface area for capturing airborne particles without significantly increasing the filter volume. Unfortunately, the pleating process is only applied in the filter industry for particle filters. No equivalent exists for air filters intended to capture gaseous pollutants from air. For the pleated structure shown in FIGS. 1a-c, the air (whose flow is indicated by arrow 14) must pass through the fibrous filter sheet/cloth 10 in order to become filtered from particulate pollutants.

Combination air filters have recently appeared on the market as pleated filter structures wherein activated carbon material is sandwiched as a fine granular material between two particle filter sheets or glued onto a single fibrous particle filter sheet. Their drawback is that then only a very limited amount of activated carbon material can be contained inside the filter structure, leading to only a short useful activated carbon filter lifetime. Also here, air must still be passed through the composite filter sheet, thereby incurring a steeply increasing air pressure drop when the amount of activated carbon material inside the filter structure is increased.

Desirable would be a filter structure suitable for removing gaseous pollutants from air, which is pleated in a similar manner to state-of-the art particular filters—thereby allowing advantage to be taken of the industrially mature mass-manufacturing processes which exist for these filters—but wherein gas need not be passed through the filter sheet, but may be passed laterally across its surfaces instead—as is the case for state-of-the-art parallel plate and corrugated filters.

### SUMMARY OF THE INVENTION

The invention is defined by the claims.

According to an aspect of the invention, there is provided a filter structure for removing gaseous pollutants from a gas to be filtered, comprising a filter sheet,

wherein the filter sheet is pleated so as to form a series of linked sheet sections, each sheet section having a top edge and a base edge, adjacent sheet sections being joined so that the top edge joins together define a set of top creases and the bottom edge joins together define a set of bottom creases,

wherein at least one of said creases incorporates one or more slit-shaped openings for the passage of the gas to be filtered.

The pleated filter sheet has one or more slit-shaped openings at the location of one or more pleat creases, through which gas can pass. Gas to be filtered enters the filter structure transversely, by which is meant perpendicularly to a plane including top creases or the bottom creases. The gas exits through the one or more slit-shaped openings in the creases and/or through gaps between top creases. Gas passing through the filter passes substantially parallel to the planar surfaces of the sheet sections, and conduits are formed by the tapered spacing between neighbouring sheet sections.

Pollutants are removed from the gas through processes which include lateral gas diffusion as it passes across the surfaces of the sheet sections.

Gas flow substantially parallel to the filter surfaces, as opposed to gas flow through (perpendicular to) the filter surfaces, reduces the incurred gas pressure drop across the filter. For the maintenance of a desired gas flow rate across the filter, a lower incurred gas pressure drop means a smaller external force required to maintain that flow.

A pleated filter sheet, as opposed to a flat or planar filter sheet, has increased active filtering surface area, hence improving filtration efficiency for a given gas flow rate or alternatively increasing flow rate capacity for a given filtration efficiency.

There is a passage of gas from one side of the filter structure to the other via the one or more slit-shaped openings. In a simplest example, just one slit-shaped hole is incorporated into just one crease, either a top crease or a bottom crease, this one crease facilitating passage of gas from one side of the structure to the other.

In another example, each top crease may incorporate one or more slit-shaped openings for the passage of the gas to be filtered; at least one slit incorporated into each one of the top creases.

A greater number of slits decreases incurred gas pressure drop across the filter and hence increases flow rate capacity. In the case that only the top creases incorporate openings, air enters the filter structure by passing in-between the base creases, and exits the filter structure passing through the openings in the top creases. In this case, only downward-facing surfaces (surfaces facing toward the base creases) perform the active filtering function, the top-facing surfaces not coming into contact with the gas to be filtered.

According to another example, each bottom crease incorporates one or more slit-shaped openings for the passage of the gas to be filtered.

In this case, gas to be filtered is able to pass through the base creases on its entry into the filter structure, subsequently exiting through the spaces between the top creases. In this case, top-facing surfaces of the sheet elements are able to perform an active filtering function.

The filter sheet sections may be for blocking the passage of the gas to be filtered. A filter sheet which is substantially gas impervious ensures that gas enters and exits the filter structure only through the slit-shaped openings in the creases of the pleats or the gaps between creases. This ensures that the gas does not need to change direction, expand or contract during its passage through the filter, and this in turn results in a minimization of incurred gas pressure drop across the filter.

The angle between adjacent sheet sections may be 45 degrees or less.

The spacing between adjacent top creases or between adjacent bottom creases may be between 0.5 mm and 5 mm.

Transport of gas pollutants to side-walls occurs via lateral diffusion. A fast lateral diffusion rate, sufficient to guarantee high efficiency in extraction of pollutants across the surface of a sheet element, is achieved by keeping the pitch between each sheet element between 0.5 mm and 5 mm. This small lateral spacing between creases also adds to the compactness of the filter structure, minimizing overall volume.

The length between the base edge and top edge of each sheet section may be between 10 mm and 60 mm.

The filter sheet may comprise an absorptive sheet of a chemically-impregnated fibrous material such as paper or glass-fibre or non-woven fabrics; or

the filter sheet may comprise gas-oxidising elements capable of catalytic gas oxidation; or

the filter sheet may comprise activated carbon elements containing activated carbon material.

Different filtration materials may facilitate removal of different kinds of pollutant substance. For removal of formaldehyde and/or small acidic gases (e.g. SO₂, acetic acid, formic acid, HNOx) from a carrier gas, use may be made of impregnated filter materials capable of chemically absorbing these gasses. Absorption can occur via acid-base interactions or through a chemical condensation reaction.

Alternatively, the filter sheet may comprise an oxidative filtration material (for example UV-irradiated TiO2 material on an inorganic carrier material), capable of removing pollutants such as formaldehyde and volatile organic hydrocarbon gasses (VOCs) via catalytic oxidation.

Adsorptive active carbon material may also be used as a filtration material, allowing for removal from a carrier gas of many VOCs and some inorganic gasses, such as NO₂, O₃ and radon. Air cleaning in this case occurs through adsorption of gaseous pollutants in the micropores of the activated carbon.

According to another aspect of the invention, there is provided a method of producing a filter structure for the removal of gaseous pollutants from a gas to be filtered, comprising:

providing a filter sheet having one or more rows of parallel slit-shaped openings 80, wherein the rows run parallel with a width direction of the slit-shaped openings;

pleating the filter sheet by forming folds running parallel with a length direction of the slit-shaped openings, a fold being formed at least at the location of each slit-shaped opening, wherein the direction of each fold is alternate to that of any adjacent fold, thereby generating a pleated series of sheet sections.

Manipulation is required of only one main component (the filter sheet) for the execution of the method and hence this provides a simplification compared to methods requiring the assembling of a number of parts.

A continuous filter sheet might first be provided, with holes being formed subsequently by punching or cutting for example. Alternatively, a filter sheet might be provided with holes already realised, either by a prior process of punching or cutting, or through a sheet moulding process which excludes material from the regions occupied by the holes.

The sheet may include a single row or more than a single row of openings. If just a single of row of openings is provided in the sheet, each crease (top or base) has a maximum of one slit incorporated into it.

One or more folds may be formed running parallel with the length direction of the slit shaped openings but not coincident with any slit-shaped openings.

Where folds are formed, for example, at all points equidistant from, as well as coincident with, the slit-shaped openings, two sets of creases are formed: one which incorporates openings, and one which is free from openings. Where the slits in each row are uniformly spaced with respect to one another, the filter structure produced by the method for example has a top set of creases, each incorporating one or more slit-shaped openings, and a base set of creases, none of which incorporate slit-shaped holes. Alternatively, the holes may be non-uniformly spaced, or, equivalently, folds non coincident with holes may be formed in a non-uniform arrangement. Thus, there may be formed top and bottom sets of creases, wherein some but not all of the top creases incorporate holes and/or some but not all of the bottom creases incorporate holes.

The filter sheet sections may for blocking the passage of the gas to be filtered.

The spacing between neighbouring holes of the same row may be between 10 mm and 60 mm. The angles of the provided folds may be such that the spacing between adjacent top creases or between adjacent bottom creases is between 0.5 mm and 5 mm.

According to another aspect of the invention, there is provided a method of filtering a gas to remove gaseous pollutants, comprising

passing the gas through a filter structure, said filter structure comprising:

a filter sheet which is pleated so as to form a series of linked sheet sections, each sheet section having a top edge and a base edge, adjacent sheet sections being joined so that the top edge joins together define a set of top creases and the bottom edge joins together define a set of bottom creases, wherein at least one of said creases incorporates one or more slit-shaped openings for the passage of the gas to be filtered,

wherein the method comprises:

passing the gas between the sheet sections, so that the gas enters into the filter structure through and/or between the base creases and exits the filter structure through and/or between the top creases.

This method of filtration minimises incurred gas pressure drop across the filter structure, as compared, for example, with methods which require gas to be passed directly through the material of a filter sheet, from one side to the other. In the method according to this invention, active filtration occurs via lateral diffusion towards adsorbing or absorbing or oxidizing surfaces inside the filter structure according to the invention, requiring the gas only to be passed across (substantially parallel to) the surface of the filter sheet. Passage of gas from one side of the filter structure to the other side of the filter structure is facilitated by the slit-shaped openings, which naturally incur a greatly reduced pressure drop from one side of the structure to the other side of the structure.

The filter sheet sections may be for blocking the passage of the gas.

### BRIEF DESCRIPTION OF THE DRAWINGS

Examples of the invention will now be described in detail with reference to the accompanying drawings, in which:

FIGS. 1a-c show an example of a pleated mechanical particular filter known from the prior art;

FIG. 2 shows an example of a corrugated gaseous pollutant filter known from the prior art;

FIG. 3 shows an example a parallel plate filter structure known from the prior art;

FIG. 4 shows an example of a filter structure in accordance with the invention;

FIG. 5 shows a side view of an example of a filter structure in accordance with the invention;

FIG. 6 depicts a second example of a filter structure in accordance with the invention; and

FIG. 7 shows an example of a method of manufacturing a filter structure in accordance with the invention.

### DETAILED DESCRIPTION OF THE EMBODIMENTS

The invention provides a pleated filter structure for the removal of gaseous pollutants from a gas mixture to be filtered. The structure comprises an ideally air-impervious filter sheet, being pleated to as to form an adjacent series of slit shaped conduits for the passage of air through the structure, each bounded on either side by the folded sections of the filter sheet, these being joined by a series of top creases and bottom creases. The top and/or bottom creases incorporate slit-shaped openings allowing passage of a gas mixture into and/or out of the structure. Gas to be filtered enters through one side of the structure, passes laterally across the filter sheet section surfaces and exits through the other side. Also provided are methods for the manufacture of a pleated filter structure, comprising forming rows of slit-shaped openings in a filter sheet and providing folds, in alternating directions, along the lengthwise extensions of adjacent rows of openings. Methods for filtering a gas are also provided.

In a simplest embodiment, the invention comprises a single sheet of active filtering material, pleated and with slits provided at one or more of the pleat creases for the passage of air into and/or out of the device. A pleated structure allows for greater active filtering surface area, as compared with flat, planar sheets. An air passage laterally across surfaces, as opposed to through them, allows for a significantly reduced air-pressure drop across the device. Reduced air pressure drop means that air may be passed through the filter structure with less effort, mitigating energy costs where the airflow through the filter is for example fan or vacuum-assisted, or allowing for a faster flow rate of air across the device.

The invention in its most general form may be used for filtering gaseous pollutants from any arbitrary background gas mixture. Merely for ease of description, in examples described below, reference is frequently restricted to the particular case of filtering of air. Reference to air filtration, however, is not to be understood as limiting to the general applicability of the invention to other gas bases/carriers.

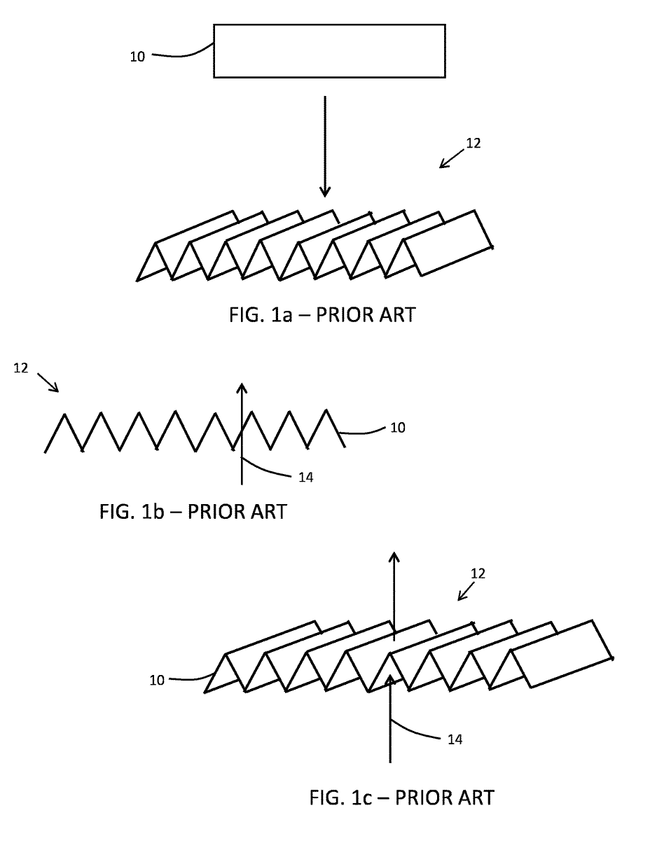

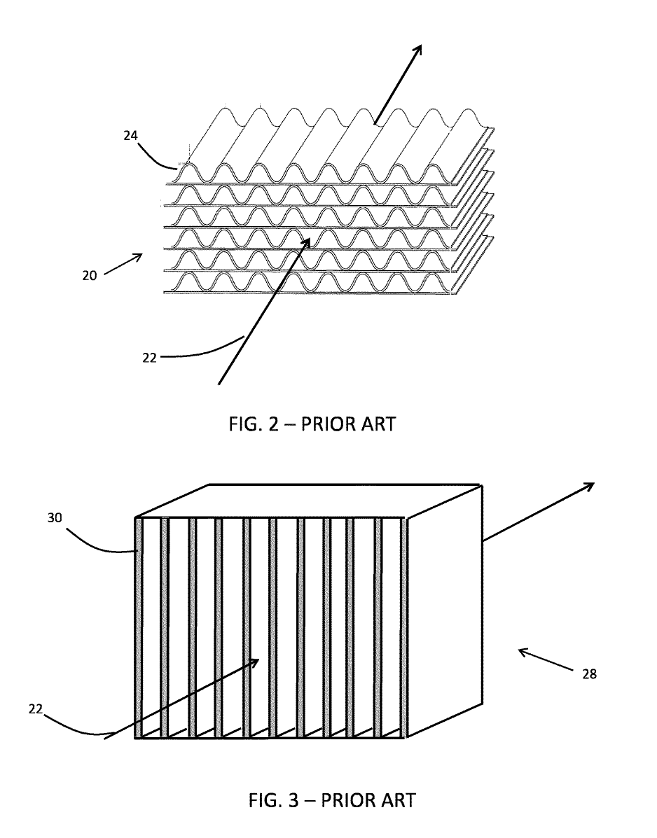

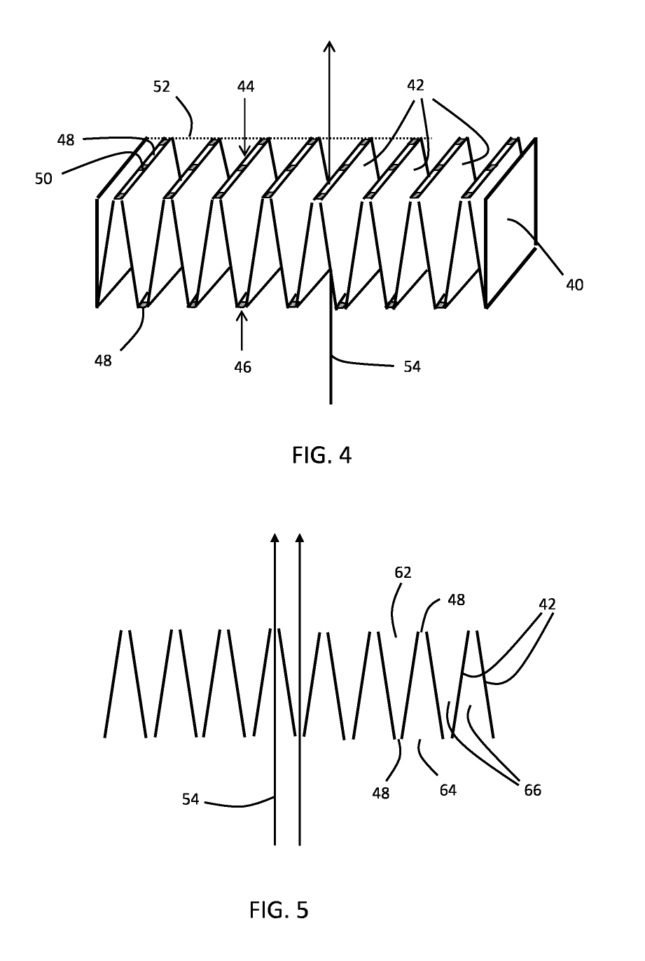

As described above, air/gas filtration devices adapted for the passage of air parallel to active filtering surfaces are known, and examples are shown in FIGS. 2 and 3. Pleated filter structures are also well known, and an example shown in FIGS. 1a-c. However, these are currently restricted to the field of particle filtration, and require air to be passed through the material of the filter sheet, rather than laterally across. The invention is based on combining the advantageous functionalities of both the pleated and the parallel-plate filter structures to provide a pleated filter structure across whose active surfaces air to be filtered can pass laterally.

In FIG. 4 is shown an example of a simple embodiment of the invention. A filter sheet 40 has regularly spaced folds in alternating directions so as to form a pleated structure comprising a series of linked sheet sections 42, adjacent sheet sections being joined at one edge, and these joins together defining a set of top creases 44 and a set of bottom creases, 46. Into said creases are incorporated one or more slit-shaped openings 48 for the passage of air. Slit shaped openings in the same crease are separated by bridges of sheet material 50.

The example of FIG. 4 further comprises a rigid frame 52 for housing the filter sheet 40 and for maintenance of the pleated shape. However, in other examples, a rigid frame may not be required. For example, the filter sheet may be comprised of a material which holds its shape without external mechanical support. Alternatively the filter structure might be incorporated as a component within a larger structure or system which already comprises elements for housing the filter sheet.

Air to be filtered 54 enters the structure through the base and exits through the top (or vice versa in alternative examples). The slit-shaped openings in the creases allow gas to pass from one side of the filter sheet to the other without having to pass through the material of the filter sheet itself.

In FIG. 5 is shown a schematic diagram of a cross section of the example filter structure of FIG. 4, indicating more clearly the air flow path through the device. Gas enters the structure through the slits 48 provided in bottom creases 46 and/or by passing through gaps 64 separating bottom creases. Upon entering, gas is directed through slit-shaped conduits 66 formed by the tapered spacing between neighbouring sheet sections 42. Sheet sections essentially form a stack of absorption elements defining a plurality of slit-shaped tapered air conduits, similar to the straight conduits in a parallel-plate filter structure. Air can be passed through the conduits with incursion of only a small pressure drop from one side to the other. As it passes through the conduits, the air makes surface contact with constituent sheet sections and gaseous pollutants are removed from the gas through processes of lateral gas diffusion or oxidisation.

In the particular example of FIGS. 4 and 5, there is incorporated into each one of the creases at least one slit-shaped opening 48. However in a simplest example, just one slit-shaped opening is incorporated into just one crease, either a top crease 44 or a bottom crease 46, this one crease facilitating passage of gas from one side of the structure to the other. Inclusion of just one slit however, might have an impeding effect on air flow capacity through the filter structure.

In an alternative example, there may be slits incorporated into some or all top creases but none in bottom creases, or vice versa. In the case of the former, air enters the filter structure only through gaps 64 between bottom creases, and consequently may exit the structure only through the slits provided to corresponding top creases 48. In this case only downward-facing surfaces (surfaces facing toward the base creases) perform the active filtering function, the top-facing surfaces not coming into contact with the gas to be filtered.

In a preferred example, the filter sheet comprises a material which is substantially air impermeable. For efficient functionality of the filter, air must enter and exit the structure only through slit-shaped openings in creases, and/or through spaces between adjacent creases. This ensures that the gas does not need to change direction, expand or contract during its passage through the filter, and this in turn results in a minimization of incurred gas pressure drop across the filter.

In different examples, the angle formed at each crease, and correspondingly the spacing between adjacent top creases or between adjacent bottom creases, may vary. In a particular example, the angle formed between adjacent sheet sections may be 45° or less. Varying the angle between neighbouring sheet sections affects the internal dimensions of air conduits 66, and thereby influences fluid dynamical properties of the device pertaining to air flow though the structure.

Efficient extraction of pollutants from inflowing air relies upon a fast rate of lateral gas diffusion to side walls of the conduits. A sufficiently fast rate may be achieved by limiting the pitch between adjacent sheet sections to just a few millimetres. In a preferred example, the angle between adjacent sheet sections is chosen such that the spacing between adjacent top creases or between adjacent bottom creases is limited to between 0.5 mm and 5 mm. This small lateral spacing ensures that lateral diffusion can occur at a sufficiently fast rate to guarantee high efficiency in extraction of pollutants.

The lengths of sheet sections between top and base edges may also vary in different examples. In an example, the length between edges is between 10 mm and 60 mm. The effective lifetime of the filter structure varies in proportion to its overall volume, and hence, for a given number of sheet sections, extending their height may increase effective lifetime. Compactness of the structure may also be consideration however, in which case smaller heighted sheet sections might be preferred.

In different examples, the filter sheet may be comprised of one of a number of different materials, suitable for removing different kinds of pollutant substance. In one embodiment, for example, the filter sheet might comprise a chemically-impregnated carrier, the impregnants capable of chemically absorbing pollutant gasses from the air, via, for example, one or more acid-base interactions or through perhaps a chemical condensation reaction. Impregnated filter materials are particularly applicable in the case of removal of formaldehyde and/or small acidic gasses such as SO₂, acetic acid, formic acid or HNOx.

In a particular example, the filter sheet comprises a carrier sheet of hydrophilic fibrous cellulose (crepe) paper or glass-fibre material, impregnated with a suitable volume of an aqueous solution comprising 25% w/w Tris-hydroxymethyl-aminomethane, 15% w/w potassium-formate, 15% w/w potassium bicarbonate, and 45% water. This is particularly suitable for removal of formaldehyde and/or acidic gasses from air.

In an alternative example, a similarly constituted carrier sheet is instead impregnated with an aqueous solution comprising 35% w/w citric acid and 65% w/w water. This embodiment is particularly applicable to the absorption of alkaline gasses such as NH₃ and amines.

Pollutant substances may be removed from air through processes of gas-oxidisation. In this case, the filter sheet may be comprised instead of an inorganic material such as glass-fibre or quartz fibre, which has been coated with TiO₂, and subsequently irradiated with ultraviolet light, of wavelengths preferably below 400 nm. The resultant filter sheet is suitable for removing gaseous pollutants such as formaldehyde and volatile organic hydrocarbon gasses (VOCs) via a process of photo-catalytic oxidation.

In a final example, the filter sheet may be comprised of elements containing activated carbon material, this being particularly suited to the removal of many VOCs as well as some inorganic gasses, such as NO₂, O₃ and radon.

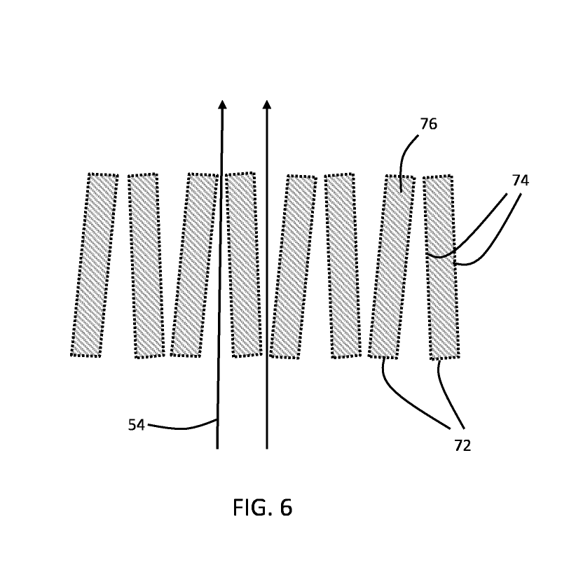

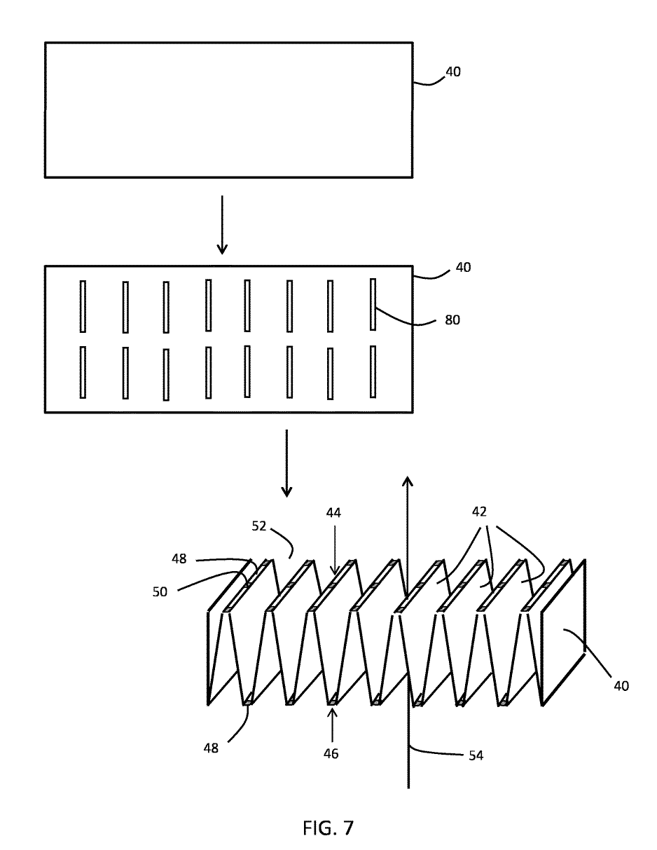

In FIG. 6 is shown an example of a filter structure in accordance with the invention, having filter sheet comprising activated carbon material. Sheet sections 72 each comprise a quantity of activated carbon material 76, which is sandwiched between two very thin fibrous webs 74 of a porosity, in an ideal example, or 50% or greater. The activated carbon material 76 may be present in the form of granules, or alternatively may in extruded or otherwise compressed form. Granular activated carbon material may be fixed in position between porous webs 74 by means, for example, of glue or other adhesive. Air cleaning in this example occurs through a process of adsorption of gaseous pollutants in the micropores of the activated carbon.

An important advantage of the present invention in comparison with, for example, prior parallel plate or corrugated filter structures is the applicability of simple manufacturing processes, in particular processes substantially similar to those already employed in the mass-production of pleated particle filters such as that shown in FIG. 1.

In FIG. 7 is shown a simple example of a process for the manufacture of a filter structure in accordance with the invention. In this example, a rectangular filter sheet 40 is first provided, and this sheet subsequently manipulated in order to realise one or more rows of parallel slit-shaped openings 80. A process of punching or cutting, for example, may be applied in order to form the holes, leaving bridges of sheet material separating adjacent rows. However, in alternative examples, a filter sheet might be provided with holes already realised, either by a prior process of punching or cutting, or through a sheet moulding process which excludes material from the regions occupied by the holes.

To the filter sheet, with openings now formed, is applied a pleating process, comprising forming folds running parallel with the lengthwise extensions of the slit-shaped openings, the direction of each fold alternate to that of any adjacent fold. By folding along the extensions of the slits 80, the slits become incorporated into the creases formed by the folds, thereby generating the structure characteristic of the invention.

The filter sheet may comprise a single row or more than a single row of openings. If just a single row is formed, each crease (top or base) has a maximum of one slit incorporated into it. Where more than one row is provided, more than one slit features in each crease. In FIG. 7, for example, two rows of slits are formed in the filter sheet, and correspondingly two openings are formed in each crease.

The method requires manipulation of only one main component (the filter sheet 40) and hence represents a significant simplification in comparison with methods of manufacture of parallel plate and corrugated filter devices, which require the production and assembly of a number of distinct parts. In addition, the method is substantially similar to the well-established manufacturing process for pleated particle filters, a simple example of which method is shown in FIG. 1a. The method of FIG. 7 differs from that of FIG. 1a only by the inclusion of the extra step of forming slit-shaped holes 80 in the sheet prior to folding. Such a step could easily be added to existing manufacturing process flows without significant alteration to equipment or mechanisms.

Other variations on the method may be applied in order to produce filter structures having differing arrangements of creases and openings. In the particular example of FIG. 7, folds are formed only along the extensions of the slits, and correspondingly a filter structure is produced having slits incorporated within each and every crease. However, in alternative examples, additional folds may be formed parallel, but not coincident, with lengthwise extensions of slit shaped openings, thereby producing filter structures having some creases which are free from openings.

In one embodiment, for example, folds are formed at all points equidistant from, as well as coincident with, the slit-shaped openings. In this way, two sets of creases are formed: one which incorporates openings, and one which is free from openings. Where the slits in each row are uniformly spaced with respect to one another, the filter structure produced by the method for example has a top set of creases, each incorporating one or more slit shaped openings, and base set of creases, none of which incorporate slit-shaped holes.

Alternatively, the holes might be non-uniformly spaced, or, equivalently, folds non-coincident with holes may be formed in a non-uniform arrangement. In this way there may be formed top and bottom sets of creases, wherein some but not all of the top creases incorporate holes and/or some but not all of the bottom creases incorporate holes.

Additionally, the heights of generated sheet sections 42 may be varied by varying the spacing between neighbouring folds. In the simple example of FIG. 7, wherein folds are provided only along lines coincident with formed openings, this corresponds to varying spacing between adjacently formed holes. In one preferred example, spacing between neighbouring holes of the same row might be between between 10 mm and 60 mm.

In different examples, filter structures may comprise filter sheets having differing compositions, suited for extraction of different kinds of pollutants, and these may require variations on the general method of production. For example, the filter sheet might comprise a chemically impregnated carrier, the impregnants capable of chemically absorbing pollutant gasses from the air, via, for example, one or more acid-base interactions or through perhaps a chemical condensation reaction. Impregnated filter materials are particularly applicable in the case of removal of formaldehyde and/or small acidic gasses such as SO₂, acetic acid, formic acid or HNOx.

For this example, it is advantageous to start with a carrier sheet of hydrophilic cellulose (crepe) paper or glass-fibre material or non-woven fabric, to form holes and to pleat in accordance with the method describe above, and then subsequently to impregnate the sheet with a suitable impregnant or mixture of impregnants. Suitable such mixtures have been described in detail above.

In addition to pleating, the method may in some examples be supplemented by a further process of framing; providing a rigid structure to the filter sheet for its housing and for the maintenance of the pleated shape. In some cases, the dimension and shape of the pleats may be additionally supported and fixed in position by means of extra spacers between the pleats. However, in other examples, these steps are omitted—for example, where the filter sheet is comprised of a material which holds its shape without external mechanical support, or where the filter structure is to be incorporated as a component within a larger structure of system which already comprises elements for housing the filter sheet.

Applications for a filter structure for extraction of gaseous pollutants from air are numerous and widespread. The particular advantages of the present invention over prior similar filters include a reduced air pressure drop across the filter. This makes the filter particularly well suited to applications in which gas to be filtered is mechanically assisted in its passage across the filter, for example via a fan or pump. Reduced air pressure drop means that air may be passed through the filter structure in these cases with less effort, mitigating energy costs, or alternatively allowing for a faster flow rate of air across the device.

The above described filter structure may be readily incorporated within larger air cleaning units or air filter stacks. The filter may be placed, for example, in a series combination with one or more additional filters, such as particle filters. In this case, a particle filter is preferably placed upstream from the gas filter(s) in order to protect the latter from particle deposits upon active filtering surfaces. Alternatively, one or more variant embodiments of the invention may be placed in series combination with themselves, for example, embodiments having filter sheets suitable for the extraction of different sorts of gaseous pollutant.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An air filter structure for removing gaseous pollutants from air to be filtered, comprising a filter sheet,
wherein the filter sheet is pleated so as to form a series of linked sheet sections, each sheet section having a top edge and a base edge, adjacent sheet sections being joined so that the top edge joins together define a set of top creases and the bottom edge joins together define a set of bottom creases, the sheet sections being gas impervious;
wherein at least one of said creases incorporates one or more slit-shaped openings for the passage of the air to be filtered.

2. An air filter structure as claimed in claim 1, wherein each top crease incorporates one or more slit-shaped openings for the passage of the air to be filtered.

3. An air filter structure as claimed in claim 1, wherein each bottom crease incorporates one or more slit-shaped openings for the passage of the air to be filtered.

4. An air filter structure as claimed in claim 1, wherein the angle between adjacent sheet sections is 45 degrees or less.

5. An air filter structure as claimed in claim 1, wherein the spacing between adjacent top creases or between adjacent bottom creases is between 0.5 mm and 5 mm.

6. An air filter structure as claimed in claim 1, wherein the length between the base edge and top edge of each sheet section is between 10 mm and 60 mm.

7. An air filter structure as claimed in claim 1, wherein
the filter sheet comprises an absorptive sheet of chemically-impregnated fibrous material such as paper or glass-fibre or non-woven fabric; or
the filter sheet comprises gas-oxidising elements capable of catalytic gas oxidation; or
the filter sheet comprises activated carbon elements containing activated carbon material.

8. A method of producing an air filter structure for the removal of gaseous pollutants from air to be filtered, comprising:
providing a filter sheet having one or more rows of parallel slit-shaped openings, wherein the rows run parallel with a width direction of the slit-shaped openings;
pleating the filter sheet by forming folds running parallel with a length direction of the slit-shaped openings, a fold being formed at least at the location of each slit-shaped opening, wherein the direction of each fold is alternate to that of any adjacent fold, thereby generating a pleated series of sheet sections, the sheet sections being gas impervious.

9. A method as claimed in claim 8, wherein one or more folds are formed running parallel with the length direction of the slit shaped openings but not coincident with any slit-shaped openings.

10. A method as claimed in claim 8, wherein the spacing between neighbouring holes of the same row is between 10 mm and 60 mm.

11. A method as claimed in claim 8, wherein the angles of the provided folds are such that the spacing between adjacent top creases or between adjacent bottom creases is between 0.5 mm and 5 mm.

12. A method of filtering air to remove gaseous pollutants, comprising
passing the air through a filter structure, said filter structure comprising:
a filter sheet which is pleated so as to form a series of linked sheet sections, each sheet section having a top edge and a base edge, adjacent sheet sections being joined so that the top edge joins together define a set of top creases and the bottom edge joins together define a set of bottom creases, wherein at least one of said creases incorporates one or more slit-shaped openings for the passage of the air to be filtered, the sheet sections being gas impervious;
wherein the method comprises:
passing the air between the sheet sections, so that the air enters into the filter structure through and/or between the base creases and exits the filter structure through and/or between the top creases.

13. An air cleaning unit, comprising an air filter structure according to claim 1.

14. An air filter stack, comprising an air filter structure according to claim 1.

15. A method as claimed in claim 10, wherein
the filter sheet comprises an absorptive sheet of chemically-impregnated fibrous material such as paper or glass-fibre or non-woven fabric; or
the filter sheet comprises gas-oxidising elements capable of catalytic gas oxidation; or
the filter sheet comprises activated carbon elements containing activated carbon material.
